(19) United States
(12) Patent Application Publication
(10) Pub. No.: US 2002/0004784 A1
(43) Pub. Date: Jan. 10, 2002

(54) Systems and methods for protecting information carried on a data network

(76) Inventors: Francis Forbes, Napa, CA (US); Benjamin J. Franz, Napa, CA (US)

Correspondence Address: Ropes & Gray, One International Place, Boston, MA, 02110-2624, US

(21) Appl. No.: 09/828,464

(22) Filed: Apr. 6, 2001

Related U.S. Application Data
(60) Provisional application No. 60/195,574, filed on Apr. 6, 2000.

(51) Int. Cl. G06F 17/60

(52) U.S. Cl. 705/51

(57) ABSTRACT

A system and method for secure data transmission, data storage and data retrieval over a network is disclosed. The data containing, for example, sensitive information such as billing and shipping records in a commercial transaction, is encrypted and placed on one system, with the encryption/decryption key placed on another system. The only relationship between the systems is the fact that they have exchanged information. This system is difficult to breach because both systems need to be compromised in order to access the encrypted data.

### CROSS-REFERENCE TO OTHER PATENT APPLICATIONS

This application is claims the benefit of U.S. provisional Patent Application No. 60/195,574, filed Apr. 6, 2000.

### FIELD OF THE INVENTION

This invention relates to systems and methods for securely maintaining and transferring information across a data network, and more specifically, to methods and systems that organize the storage of encrypted information and key information in a manner that increases the security of the system, and more readily allows a merchant to employ state information for completing a transaction.

### BACKGROUND OF THE INVENTION

Today, on the Internet it is often desirable for a computer operated under the control of a merchant (“the server”) to obtain information offered by a customer and transmitted by a computer operating under the control of the customer (“the client”) to the server. It is also, given the nature of the information commonly transmitted during such a transaction, to provide a measure of security, thereby avoiding the risk of exposing the transmitted information to an interception by third parties that have access to the network. It is further desirable to assure that the information is from an authentic source.

To provide for secure transactions, several systems have been developed including those described in the Visa and MasterCard's Secure Electronic Transaction (SET) Specification, Feb. 23, 1996 (hereinafter ,,SET”). Other such secure payment technologies include Secure Transaction Technology (,,STT”), Secure Electronic Payments Protocol (,,SEPP”), Internet Keyed Payments (,,iKP”), Net Trust, and Cybercash Credit Payment Protocol.

Although these systems can work well, they are not automatic and often require the customer to operate software that is compliant with the secure payment technology. Thus a merchant is not provided with a system that automatically has the customer deliver secure information to the merchant site, where the merchant can decrypt the information for the merchant's use.

### SUMMARY OF THE INVENTION

The systems and methods described herein include e-commerce systems that provide a secure way for a client to request a sever to execute an action, for example, an order request, at the merchant's web site, i.e., the server, while avoiding retention of unencrypted (plain) confidential information, such as credit card and other billing information, of the client at the server.

More particularly, the systems and methods described herein include methods wherein the client accesses the server. If client does not have valid state information generated from a previous transaction, then the server returns a ‘base’ uncustomized response, for example, a blank order form. If the client does have valid state information from a previous transaction, the server extracts and decrypts the state information using the clients previously stored key and validates with previously generated checksums. The server may then return a response customized appropriately with client information, without storing the state data permanently after decryption.

If the client does not have a previously stored key on the server and submits information to the server, the information from the submission is selected and encrypted with a random key. The encrypted information is returned to the client for storage with a checksum verifying data integrity. The key is stored in a database that matches keys and clients along with a checksum verifying data integrity.

If the client does have a previously stored key on the server and submits new unstored information to the server, the information from the submission is selected and integrated with previously stored information appropriately, and then encrypted with the previously stored key for this client. The encrypted information is returned to the client for storage along with a checksum verifying data integrity and a checksum verifying data integrity is updated and stored on the server.

In one aspect of the invention, a method for securely storing information and transferring information between a client and a server includes the server receiving a client request to perform a server action and data that include sensitive information. The server in response performs the action and generates an encryption key associated with the client, encrypts at least a portion of the sensitive information using the encryption key to form an encrypted cookie containing the sensitive information and returns to the client the encrypted key cookie. The server deletes the unencrypted sensitive information from a server database and stores on the server database only the encryption key associated with the client identifier.

In a subsequent client request to perform a server action, the server receives from the client the encrypted cookie which contains the sensitive information and decrypts the received encrypted cookie with the stored encryption key. Hence, the server has in its possession the information required to execute the transaction, unless the client modifies portions of the sensitive information. After the order is completed and verified by the client, the server generates a new encryption key and encrypts the sensitive information and sends the updated key to the client.

In another aspect of the invention, instead of the server storing the key, the server encrypts the data using the encryption key and returns to the client a key cookie that includes the encryption key, deletes the plain data from a server database and stores only the encrypted data.

Embodiments of the invention may include one or more of the following features. The encryption/decryption key may be a one-time pad generated from a truly random number. Truly random numbers are important in cryptography, since the number used to generate the key should be unpredictable. The server database may associate a client identification with the encryption key or the encrypted data stored in the server's database. The client identification may be further encrypted, for example, by forming a hash value. A checksum may be generated and transferred between the server and the client to verify data integrity. Alternative or in addition, digital signatures may be employed to authenticate the client.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a client and a server connected via a network;

FIG. 2 shows schematically a process flow of a first embodiment; and

FIG. 3 shows schematically a process flow of a second embodiment;

### DETAILED DESCRIPTION OF CERTAIN ILLUSTRATED EMBODIMENTS

The invention is directed to a system and method for secure data storage and retrieval over a network. In particular, the system and method described herein can be used, for example, for secure transmission and storage of sensitive information, such as billing and shipping information in commercial transactions.

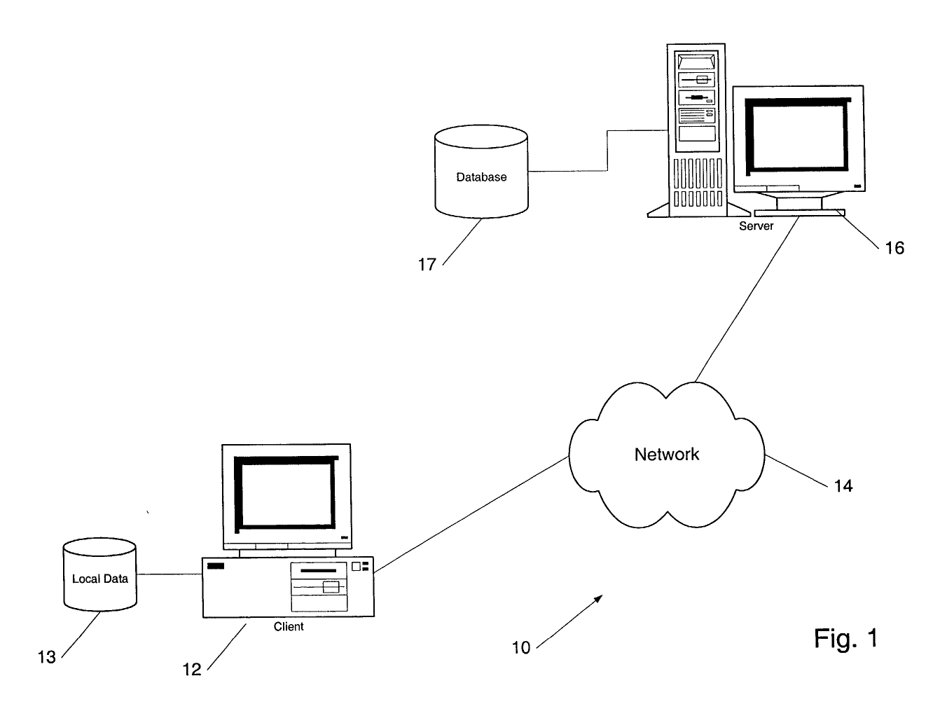

Referring first to FIG. 1 illustrates a system 10 which includes a client system 12 with a local database 13, which may be internal to the client system 12, and a merchant's server 16 which may be connected through a network 14, such as the Internet or a LAN, to the client system 12. The server 16 connects to a proprietary database 17 maintained by the server 16 for storing keys that may be employed for accessing encrypted information, or for storing encrypted data, as will be described in detail below.

For the depicted system, the client system 12 can be any suitable computer system such as a PC workstation, a handheld computing device, a wireless communication device, or any other such device, equipped with a network client capable of accessing a network server and interacting with the server 16 to exchange information with the server 16. The network client may be a web client, such as a web browser that can include the Netscape web browser, the Microsoft Internet explorer web browser, the Lynx web browser, or a proprietary web browser, or web client that allows the user to exchange data with a web server, and ftp server, a gopher server, or same other type of network server. Optionally, the client 12 and the server 16 rely on an unsecured communication path, such as the Internet 14, for accessing services an the remote server 16. To add security to such a communication path, the client and the server can employ a security system, such as any of the conventional security systems that have been developed to provide to the remote user a secured channel for transmitting data aver the Internet. One such system is the Netscape secured socket layer (SSL) security mechanism that provides to a remote user a trusted path between a conventional web browser program and a web server.

The server 16 may be supported by a commercially available server platform, such as a Sun Sparc™ system running a version of the Unix operating system and running a server capable of connecting with, or transferring data between, any of the client systems. In the embodiment of FIG. 1, the server 16 includes a web server, such as the Apache web server or any suitable web server. The operation of the web server component at the server can be understood more fully from Laurie et al., Apache The Definitive Guide, O'Reilly Press (1997).

The server 16 may also include components that extend its operation to accomplish the transactions described herein, and the architecture of the server 16 may vary according to the application. For example, the web server may have built in extensions, typically referred to as modules, to allow the server to perform operations that facilitate the transactions desired by a user/merchant, or the web server may have access to a directory of executable files, each of which files may be employed for performing the operations, or parts of the operations, that implement the transactions, such as files required to create and encrypt the keys, key cookies and data of the present invention.

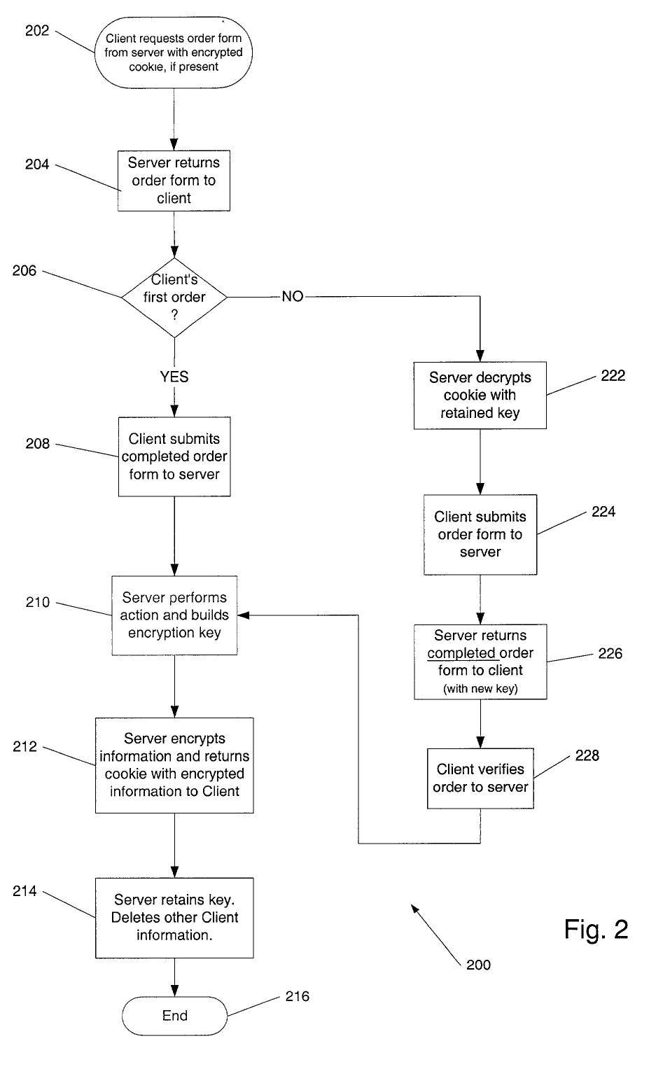

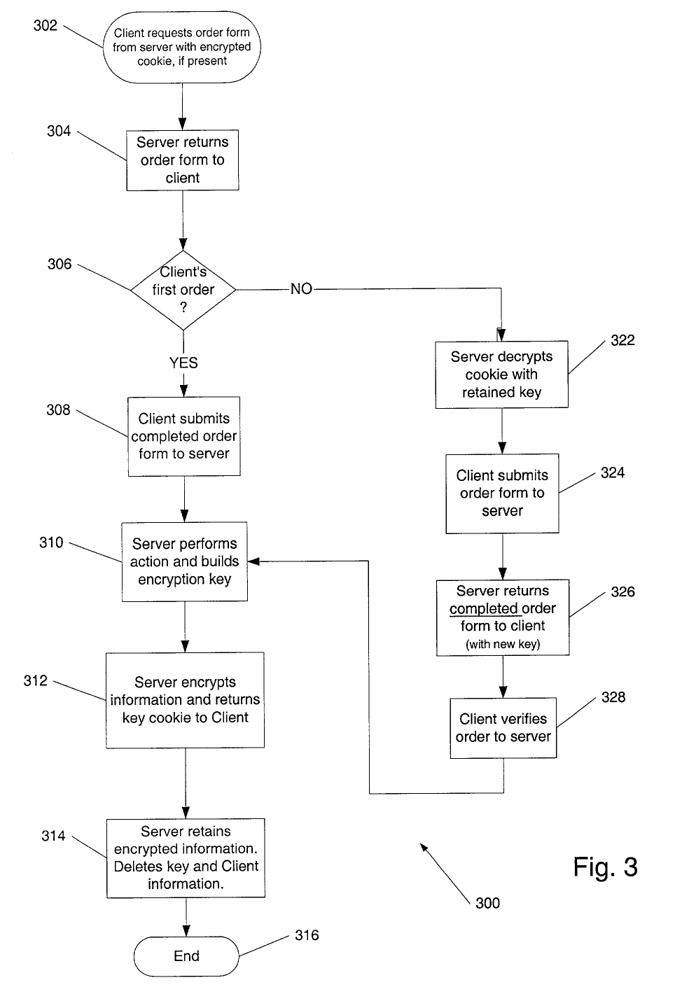

Turning now to FIGS. 2 and 3, the method according to the invention allows users to store encrypted, sensitive information related to purchases made at a merchant site, such as customer information or credit card numbers, locally on their own computers, thus eliminating the security risk of keeping this information on remote servers, and yet retaining the ability to instantly complete transactions and processes with the remote server as if the data were already on the remote server. In other words, the user need to enter the sensitive information once, during the initial session with the remote server, even if updating other non-sensitive data, such as the actual items ordered. The remote server will use preferably “strong” encryption techniques, such as one-time pads created from truly random numbers, to encrypt the sensitive information and place it back on the user's hard drive in the form of an encrypted, server-specific information file or “cookie”. The server only retains the unique encryption key, while the sensitive unencrypted user's information is deleted, making it unavailable on the server. Alternatively, the sensitive information, instead of the encryption key, can be placed on the server data base in the form of an encrypted, user-specific information file, with the user retaining the decryption key.

When the user returns for a subsequent session to the remote server, the server will retrieve the encrypted cookie from the user's computer and decrypt it with the server's retained key. Accordingly, when the user starts a process requiring the encrypted information for completion, the server can then complete the process without prompting the user to re-enter the original sensitive information. The server may ask the user for verification of the data and the sensitive information, for example, if the credit card number or the expiration data has changed, and incorporate and encrypt any such changes into an updated cookie that will again be placed back on the user's hard drive, replacing the original file. Once the transaction or process is completed, the remote server will again delete the user's information.

The encryption key may be generated by a one-time pad. A new encryption key should be used for any transaction, even if the sensitive information has not changed between orders, so as not to compromise the security of the system. The key may also be tied to the time at which the key was generated. This therefore allows the server to employ time as the identifier of a key, and further reduces the amount of personal or identification information that needs to be stored an the server. Optionally, the key may be tied to any other information suitable for identifying what key is to be employed for decrypting the information contained in the cookie.

Returning now to FIG. 2, the exemplary data transferred between a client and a server can be an order form that includes data and, more particularly, sensitive information, such as billing and shipping information and client contacts. A process 200 performs a request 202 from a client (buyer) to a server (merchant). The server recognizes from the presence of the cookie checks if this is the client's first order (cookie absent) or a subsequent order (cookie present). The server returns an order form to the client, step 204. The server may also return to the client an encrypted cookie of a cookie/key pair generated by the server. The order form may contain empty fields to be filled in by the buyer or may already contain items inserted by the merchant, such as purchase suggestions. If this is the client's first order, as determined in step 206, the client completes the order form and submits the completed order form to the server, step 208, possibly with the encrypted cookie attached. The server decrypts the encrypted cookie with the retained key. The server then performs the action, for example, fulfills the order by checking the client's credit, and generates a new encryption key pair, step 210. The server then encrypts the order information received from the client, or at least the sensitive information, such as credit card information, associated with the order, and generates a server-specific cookie which contains in encrypted form the sensitive information. The server returns the encrypted cookie to the client, optionally together with an identifier that associates the cookie with the client, step 212. The server retains the key, but deletes the encrypted cookie and any non-encrypted information from its database, step 214. The server's database may also retain an identifier for associating the client's key with the client. The identifier can be further encrypted, for example as a hash value, as is known in the art. At this point, the client has placed in a secure manner a first order with the server, the order is confirmed and processed by the server, thereby terminating the order process 200, step 216. The above keys, in fact all keys using during the exemplary processes, may be generated by a server application program using, for example, truly random numbers to generate encryption/decryption key pairs, such as a one-time pad.

If this is a subsequent order from the client, as determined in step 206, then the server has received the cookie from the previous transaction together with a request for an order form, as described above. The server decrypts the received cookie with the encryption key retained by the server, step 222. The client then completes the order form and submits the order form to the server, step 224. The server returns the completed order form to the client, preferably with a new cookie from a secure cookie/key pair, step 226. The client verifies the order form, for example, by verifying the last 4 digits of the credit card number, and optionally updates order data and/or sensitive information, step 228. The process 200 then return to step 210, with the server performing the requested action and generating a new encryption cookie/key pair. The server encrypts the sensitive information with the new key and returns the cookie to the client, step 212, while retaining the key and deleting the encrypted cookie and any non-encrypted information from its database, step 214. The order process 200 terminates with step 216.

In an alternative process 300 depicted in FIG. 3, a client (buyer) also sends a request to perform a server action 302 a server (merchant). Up to and including step 310 for both a first time order and a repeat order, the steps are identical to the steps 202, 204, 206, 208, and 222, 224, 226, and 228, respectively, of the process 200 described above with reference to FIG. 2. However, unlike the process 200 of FIG. 2, the server in this embodiment encrypts the sensitive information received from the client and returns a key cookie corresponding to the server's encryption key to the client, step 312. The server retains the encrypted sensitive information, but deletes the encryption key and any sensitive non-encrypted information from its database, step 314. Again, the server's database may also retain an optionally encrypted identifier for associating the client's encrypted sensitive information with the client. The order process 300 terminates with step 316.

To provide a most secure process for transmitting and storing the sensitive information, a new key pair is generated by the server for each new transmission of such information between the server and the client and vice versa. Since each key is truly a one-time pad and is not reused, it is virtually impossible for an unauthorized person to retrieve the information either from a database or during transmission. The server does not write the “plain”, i.e., unencrypted information onto a permanent storage medium, but rather retain the information only for a short time in volatile memory, making access to the unencrypted information even more difficult.

The sensitive information can be encrypted with the encryption key by forming, for example, an XOR-product between the sensitive information and the encryption key, as known in the art.

Unlike other systems, the buyer need not download any type of electronic-payment software component (“wallet”) to take advantage of the authorized payment process—the method is driven by software on the merchant's server.

Since the merchant retains no credit card or other sensitive information on the server, the incentive is removed for unauthorized users to attempt access to merchant records to obtain buyer credit card information. Should an unauthorized user obtain a unique buyer encryption key from the server, they would then need to also gain access to the buyer's computer to obtain the encrypted file which the key decrypts. This effort would yield the unauthorized user credit card information on only one buyer, rather than on the merchant's entire list of buyers. To hack the system both the encrypting key that is stored on the merchant server and the data stored in cookie(s) on the surfers machine must be obtained.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

We claim:

1. A method for securely storing information and transferring information between a client and a server, comprising at the server:
a) receiving said information and a client request to perform a server action,
b) responsive to receiving the client request, performing the server action and generating an encryption key assigned to the client, said encryption key being associated with a client identifier,
c) encrypting at least a portion of said information using the encryption key, thereby forming an encrypted cookie,
d) returning to the client said encrypted cookie, and
e) deleting said information from a server database and storing on the server database only the encryption key associated with the client identifier.

2. The method of claim 1, wherein said information includes a billing reference.

3. The method of claim 1, wherein said encryption key is a one-time pad.

4. The method of claim 1, wherein said client identifier is encrypted with a key different from the encryption key.

5. The method of claim 1, wherein said client identifier is encrypted by forming a hash value.

6. The method of claim 1, wherein said client identifier comprises a digital signature.

7. The method of claim 1, wherein said encryption key can be used to decrypt the encrypted cookie.

8. The method of claim 1, further including generating a checksum to verify data integrity of the encrypted cookie.

9. The method of claim 1, if the server request is a subsequent server request, after step (a):
receiving from the client the encrypted cookie, and
decrypting the received encrypted cookie with the stored encryption key.

10. A method for securely storing information and transferring information between a client and a server, comprising at the server:
a) receiving said information and a client request to perform a server action,
b) responsive to receiving the client request, performing the server action and generating an encryption key assigned to the client,
c) encrypting said information using the encryption key, thereby forming an encrypted cookie, and associating the encrypted information with a client identifier,
d) returning to the client said encryption key, and
e) deleting said encryption key a server database and storing on the server database only the encrypted information associated with the client identifier.

11. The method of claim 10, wherein said encryption key is a one-time pad.

12. The method of claim 10, wherein said client identifier is a hash function.

13. The method of claim 10, if the server request is a subsequent server request, after step (a):
receiving from the client the encryption key, and
decrypting the stored encrypted information with the received encryption key.

14. A computer program embodied in a computer readable medium, causing a computer, upon receiving via a network from a client sensitive information and a request to perform an action, to:
a) perform the server action and generate an encryption key assigned to the client, said encryption key being associated with a client identifier,
b) encrypt said sensitive information using the encryption key, thereby forming an encrypted cookie,
c) return to the client via the network said encrypted cookie, and
d) delete said sensitive information from a computer database and storing on the computer database only the encryption key associated with the client identifier.

15. The computer program of claim 14, if the request from the client is a subsequent request, causing the computer to:
before step (a), receive from the client the encrypted cookie, and decrypt the received encrypted cookie with the stored encryption key.
